(19) United States
(12) Patent Application Publication
(10) Pub. No.: US 2025/0290812 A1
(43) Pub. Date: Sep. 18, 2025

(54) TORQUE-MEASURING COUPLING

(71) Applicant: Chr. Mayr GmbH + Co. KG, Mauerstetten (DE)

(72) Inventors: Martin REICHLE, Kirchheim (DE); Frank TIMMLER, Wiedergeltingen (DE); Christoph DROPMANN, Kaufbeuren (DE)

(73) Assignee: Chr. Mayr GmbH + Co. KG, Mauerstetten (DE)

(21) Appl. No.: 18/860,488

(22) PCT Filed: Apr. 25, 2023
(86) PCT No.: PCT/EP2023/060857

§ 371 Date: Oct. 25, 2024

(30) Foreign Application Priority Data
Apr. 26, 2022 (DE) 10 2022 001 458.0

(51) Int. Cl. G01L 3/10

(52) U.S. Cl. CPC G01L 3/108

(57) ABSTRACT

The invention relates to a torque measuring coupling, which consists of a stator, a strain gauge sleeve, and, optionally, hubs connected thereto via lamellar connections. The torque measuring coupling is suitable for transmitting torque, compensating for shaft misalignment, and measuring the transmitted torque. The strain gauge sleeve is constructed in several parts, wherein in particular the expansion sleeve is radially enclosed by a coil ring and positively connected to a flange. The coil ring has an inner diameter, which is smaller than the outer diameter of the flange, and accommodates a protective tube.

The invention relates to a torque measuring coupling that is suitable for transmitting torque as well as for measuring torque and for adaptation into a drive train. The torque measuring coupling consists of a strain gauge sleeve and preferably two torsionally rigid, flexible shaft couplings. The task of the strain gauge sleeve is to measure the torque-proportional surface strain using strain gauges. The strain is then converted into a torque. The shaft couplings are used to adapt the torque measuring coupling to the drive train and to compensate for any axial, angular, and lateral displacements.

Such torque measuring couplings are used in industrial applications to monitor and measure the torque in drive trains.

Patent application DE 10 2017 004 680 A1 is known from the prior art. It describes a strain gauge sleeve that is suitable for precise torque measurement using strain gauges. The arrangement of these strain gauges in the region of the tapered cross-section and on the described spring elements allows accurate measurement even if the shaft axes are displaced relative to each other. A disadvantage of this design is that a large number of strain gauges and spring elements are required, which leads to high costs. Furthermore, the delicately designed spring elements and the strain gauges applied thereto are not protected against any damaging mechanical influences from outside. The design of the connection of the strain gauge sleeve is left largely open.

EP 1 074 826 B1 also describes a strain gauge sleeve that is intended to achieve a high level of measurement accuracy through its design and the use of shear force transducers. In regions with a reduced wall thickness, the shear force transducers are to be mounted either on the outer diameter or on the inner diameter. It is further described that one of the flanges is designed as a closed part without a through-hole. The application of the shear force transducers on the inner diameter is more complex due to the poor accessibility and thus involves higher costs. Furthermore, due to the closed design of one of the flanges, axial passage through the strain gauge sleeve is not possible. In addition, the regions containing the elements intended for torque measurement are not protected from external influences.

Furthermore, DE 101 14 338 B4 describes a torque measuring coupling that describes a specially designed adaptation flange that serves as a link from the strain gauge sleeve to the shaft coupling. The adaptation flange is intended to reduce parasitic forces caused by shaft displacement, which act upon the strain gauge sleeve and reduce the measuring accuracy. The disadvantage of the described design is that the design of the adaptation flange is associated with high production costs. Furthermore, the strain gauge sleeve is almost completely open, so that its torque measurement regions are not protected from external influences.

The object of the present invention is to design a torque measuring coupling in such a way that it is cost-effective and suitable for use in process monitoring in industrial applications and is correspondingly robust. Furthermore, a simple shaft connection and an axial feedthrough through the torque measuring coupling shall be possible.

According to the invention, the object is achieved by the features of the main claim and the auxiliary claim. Furthermore, further advantageous embodiments are described in the dependent claims.

The torque measuring coupling consists of a plurality of components. The central component is the strain gauge sleeve, which in turn has an expansion sleeve. The expansion sleeve has a cross-section that is tapered in portions along its axial extension and referred to as the sleeve portion. If a torque is transmitted with the torque measuring coupling, the greatest elastic deformation occurs in the region of the tapered sleeve portion, which is detected and measured by the strain gauges applied to the outer diameter in the region of the sleeve portion. On one side, the expansion sleeve has at the end of its axial extension a flange shape, which is suitable for connecting a lamellae pack. For this purpose, the flange shape on the front side has alternating recesses and threaded holes, each with a radius countersink, on a pitch circle in the circumferential direction. On the other side, the expansion sleeve is designed with threaded holes on the front side with a smaller pitch circle than that of the lamellae pack. The expansion sleeve is also provided with a pin on this side, which is used for centering. A flange is centered above this pin and is firmly connected to the expansion sleeve by means of fastening screws. This flange also has threaded holes with radius countersinks and recesses that are suitable for connecting the lamellae pack. Alternatively, both the expansion sleeve and the flange can be designed with holes without radius countersinks, which are suitable for direct screwing to another component without intermediate lamellae packs. In order not to have to reduce the transmittable torques of the torque measuring coupling due to the smaller pitch circle of the flange connection between the expansion sleeve and the flange compared to the pitch circle of the lamellae packs, one or both contact surfaces can be subjected to a blasting treatment, which leads to an increase in the transmittable torques. Alternatively, a disk with an increased surface roughness can be used, thus increasing the transmittable torque of this flange connection.

In addition, a coil ring, which is preferably made of a plastic, a fiber-reinforced material, or an aluminum alloy, is pressed onto the expansion sleeve or glued thereto. The coil ring has an inner diameter that is smaller than the outer diameter of the flange that is connected to the expansion sleeve. The coil ring performs a plurality of functions, wherein it is not involved in torque transmission. The coil ring is used to accommodate a protective tube, which is provided with an absorber foil on its outer diameter in the region of the coil ring. The protective tube is pressed onto a receptacle in the coil ring or glued thereto. On the other side of the protective tube, said protective tube projects axially into a tube receptacle of the expansion sleeve. In the tube receptacle, the protective tube is embedded in a substantially U-shaped plastic or rubber ring or a ring made of another sealing material. The protective tube does not transmit any torque. It serves as contact protection and, in combination with the tube receptacle, as a seal for the strain gauges. This protects the strain gauges from contact and contamination. The protective tube is preferably made of an aluminum alloy, a plastic, or a fiber-reinforced material.

Furthermore, the coil ring is used as a carrier for a solenoid coil, which is firmly embedded in the coil ring and sealed with a potting compound. The solenoid coil is in turn electrically connected to a printed circuit board, which is also embedded and sealed in the coil ring by means of a potting compound. For easier installation, the printed circuit board can initially be pre-installed using plastic expanding rivets during the installation process. The magnetic coil supplies power to the printed circuit board. The printed circuit board is in turn connected to the strain gauges. For this purpose, the coil ring is provided with at least one recess on the inner diameter, which is used as a cable feedthrough.

A stator is located radially at the height of the coil ring. The radial distance between the coil ring and the stator is preferably 1 mm to 10 mm. The stator contains a magnetic circuit that is suitable for inductive energy transfer to the coil in the coil ring. In addition, there is a radio receiver in the stator for receiving data transmitted from the printed circuit board. The data can be read from the stator as an analog signal and/or as a digital signal via an Ethernet connection. Wireless connections via wireless LAN or Bluetooth are also possible.

The printed circuit board contains a voltage regulator to supply power to the strain gauges. The printed circuit board also contains a controller that is used to process the signals transmitted from the strain gauges to the printed circuit board. The processed signals are then sent wirelessly to the stator. In addition, the board can also have an acceleration sensor, which can preferably record accelerations in 3 axes. In addition to the transmitted torque, the torque measuring coupling can also be used to monitor and measure vibrations and rotational accelerations.

In the axial direction, the strain gauge sleeve can be screwed to a lamellae pack on one or both sides. The lamellae pack consists of at least one lamella, which has a plurality of equally spaced holes on a pitch circle. The bores are alternately provided with flanged bushings and rings. These are used as centering devices for the mutual screwing of the lamellae packs with the strain gauge sleeve and with the hubs. In this configuration, each hub together with the lamellae pack and the strain gauge sleeve forms an articulated shaft coupling, which is torsionally rigid but axially elastic and flexurally elastic in the region of the relevant lamellae pack. In this way, axial, lateral, and angular misalignment between the shafts can be compensated for.

The hubs, which can represent the link between the torque measuring coupling and the shafts, can have different designs. It is important that play-free connections to the shafts be used. In this way, torque shocks caused by play can be avoided, and the service life of the torque measuring coupling can be increased. Particularly suitable are clamping ring hubs, compression ring hubs, clamping hubs, or shrink disk hubs. Half-shell hubs or simple flange connections can also be used.

In addition, it is also possible to connect the strain gauge sleeve in combination with or without a lamellae connection to an overload clutch, which then protects not only the drive train, but also the torque measuring clutch from overload. Both disengaging overload clutches and slip clutches are suitable for this purpose. Wrap spring clutches, ratcheting clutches, or synchronous clutches can also be used for this purpose.

The small number of components and in particular the divisible structure of the strain gauge sleeve consisting of expansion sleeve and flange lead to a particularly cost-effective structure with less susceptibility to external influences. The divisibility makes it possible to apply the strain gauges to the expansion sleeve early in the installation process, while the outer diameter of the expansion sleeve is still easily accessible. Only at a later point in time is the coil ring, including the protective tube, which improves protection from external influences, placed on the expansion sleeve. The protective tube can also be pre-installed on the loose coil ring, and the coil can be installed and potted in advance. When the coil ring is not installed, these steps are particularly easy and cost-effective to implement. Afterwards, when the coil ring is mounted on the expansion sleeve, the circuit board is pre-installed and held in position with the help of the expanding rivets. At this stage, the wiring on the printed circuit board, i.e., its connection to the strain gauges and to the coil, can be done before the printed circuit board is also potted. Only after these installation steps is the flange connected to the expansion sleeve. The strain gauge sleeve is then screwed to the lamellae packs and the hub flanges.

Any shaft misalignment can be compensated for by the single-joint or double-joint design of the torque measuring coupling with one or two lamellae packs. Despite this compensation, resulting reaction forces occur in the expansion sleeve, which influence the measuring accuracy of the strain gauges. To counteract this, one, two, three, but preferably four or more strain gauges are provided on the circumference of the expansion sleeve in the region of the sleeve portion. By using a plurality of strain gauges, the measurement accuracy is again improved.

The strain gauges are located on the outer diameter of the expansion sleeve in the region of the sleeve portion. They are protected from accidental contact or from penetrating media by the expansion sleeve itself as well as by the protective tube and its sealing by the tube receptacle. There are no strain gauges or wiring on the inner diameter of the expansion sleeve, so that, for example, wiring can be routed axially through the interior of the torque measuring coupling without endangering the function of the torque measuring coupling by inadvertently touching the strain gauges.

Because the coil ring is designed as a closed and non-divisible ring and has a relatively low mass moment of inertia due to the materials used, the permissible speed of the coil ring does not need to be restricted, or only to a small extent, compared to the permissible speed of the hubs and lamellae packs.

In the figures:

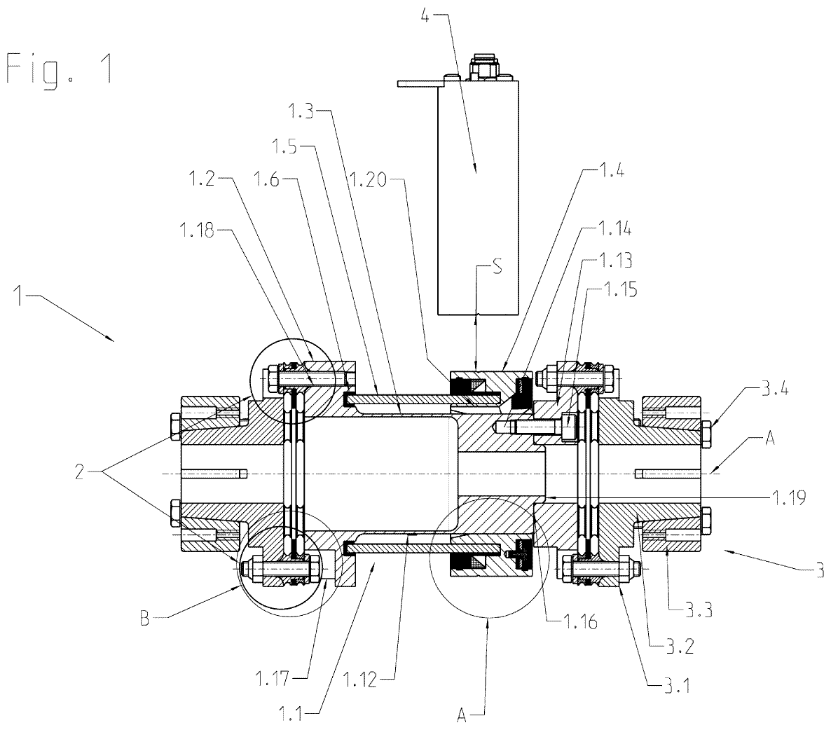

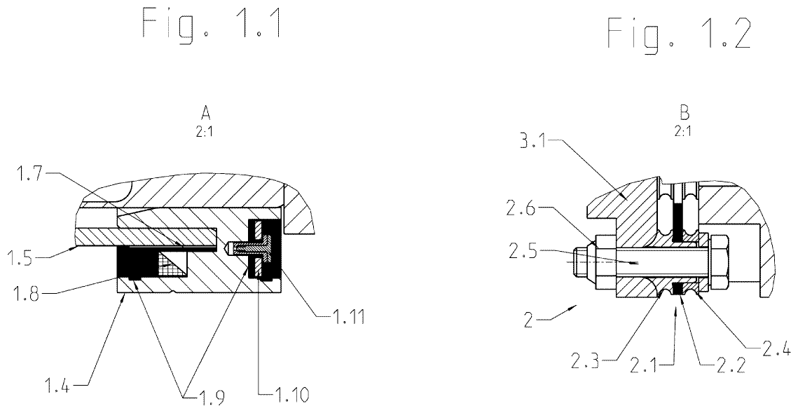

FIG. 1 shows a torque measuring coupling with clamping ring hubs in a full section

FIG. 1.1 is a detail view of the lamellae connection in a full section

FIG. 1.2 is a detail view of the coil ring in a full section

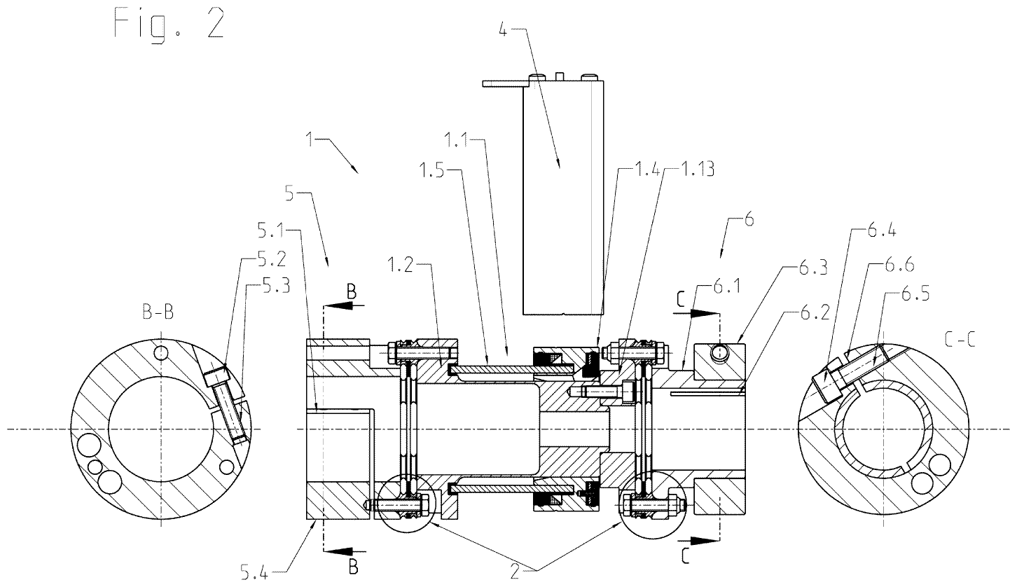

FIG. 2 shows a torque measuring coupling with a compression ring hub and a clamping hub in a full section as well as the full sections B-B and C-C of the hubs

FIG. 1 shows a torque measuring coupling (1) in a full section. This consists of a strain gauge sleeve (1.1) and hubs (3) connected thereto via lamellae connections (2). In the form shown, the hubs (3) are designed as so-called clamping ring hubs, which form the link to the shaft ends (not shown). The stator (4) is arranged at a radial distance (S) from the coil ring (1.4).

The hubs (3) are designed with a hub flange (3.1), towards the strain gauge sleeve (1.1), which is suitable for a lamellae connection (2). The clamping ring (3.3) is pulled onto the conical portion of the clamping ring hub (3.2) using the clamping screws (3.4), so that the clamping ring hub (3.2) is elastically deformed and tapers radially. In this way, the shaft ends (not shown) are clamped into the hubs (3) without play.

The lamellae connections (2) are created by alternately screwing the lamellae packs (2.1) to the hub flanges (3.1) and the strain gauge sleeve (1.1) as well as the flange (1.13) via the threaded holes with radius countersinks (1.18) provided for this purpose.

The strain gauge sleeve (1.1) is constructed in several parts and consists of an expansion sleeve (1.2) and a flange (1.13). The expansion sleeve (1.2) is provided with threaded holes (1.14) and a pin (1.19) in the direction of the flange (1.13). The flange (1.13) is centered on the pin (1.19) and screwed to the expansion sleeve (1.2) using the fastening screws (1.15). In order to increase the transmittable torque of the connection between the expansion sleeve (1.2) and the flange (1.13), a friction-increasing disk, which is not shown in FIG. 1, can be inserted between the components. It is also possible to modify the roughness of the flange (1.13) and/or the expansion sleeve (1.2) in the region of the contact surface (1.16) during surface treatment in such a way that a higher coefficient of friction is also obtained, which leads to a higher transmittable torque.

The coil ring (1.4) is fixedly connected to the expansion sleeve (1.2). The protective tube (1.5) is in turn fixedly connected to the coil ring (1.4). On the side, facing away from the coil ring (1.4), of the expansion sleeve (1.2), the protective tube (1.5) projects axially into the tube receptacle (1.6) of the expansion sleeve (1.2). In the tube receptacle (1.6), the protective tube (1.5) is provided with a contact seal or is elastically potted.

The protective tube (1.5) together with the tube receptacle (1.6), the expansion sleeve (1.2), and the coil ring (1.4) thus form a space, around the outer diameter of the expansion sleeve (1.2) in the region of the sleeve portion (1.3), that is protected from contact and sealed. In this region of the sleeve portion (1.3), the strain gauges (1.12) are applied to the outer diameter of the expansion sleeve (1.2). The wiring of the strain gauges (1.12) with the printed circuit board (1.10), which is not shown in FIG. 1, runs through the cable feedthrough (1.20) of the coil ring (1.4).

The coil ring (1.4) has an inner diameter that is smaller than the outer diameter of the flange (1.13). Furthermore, the coil ring (1.4) is a closed and non-divisible ring.

FIG. 1.1 is a detail cutout A from FIG. 1, which shows details of the coil ring assembly. The protective tube (1.5), which is fixedly connected to the coil ring (1.4), has an absorber foil (1.7) on its outer diameter in the region of the coil ring (1.4). The printed circuit board (1.10), which was fixed in the coil ring (1.4) with expanding rivets (1.11) during the installation process, is potted with a potting compound (1.9). The coil (1.8) is also inserted into the coil ring (1.4) and potted with the potting compound (1.9). The coil (1.8) is wired to the circuit board (1.10), which is not shown in FIG. 1.1.

FIG. 1.2 is a detail cutout B from FIG. 1, which shows an exemplary lamellae connection (2). The lamellae pack (2.1) is screwed to the hub flange (3.1) with screws (2.5) and nuts (2.6). The lamellae pack (2.1) is composed of at least one, but preferably of two or more, lamellae (2.2). The lamellae (2.2) are connected to each other without play via the flange bushings (2.3) and the rings (2.4).

FIG. 2 also shows a torque measuring coupling (1) in a full section together with the full sections B-B and C-C through the clamping hub (5) and the compression ring hub (6). The structure of the strain gauge sleeve (1.1) with the expansion sleeve (1.2), the flange (1.3), the coil ring (1.4), and the protective tube (1.5) does not differ from the structure described in FIG. 1. However, FIG. 2 shows alternatives to the hubs (3) for connecting the torque measuring coupling (1) to the shaft ends. On the left side, a clamping hub (5) is connected to the strain gauge sleeve (1.1) via a lamellae connection (2). The clamping hub (5) has a clamping hub slot (5.1) that extends in portions through the clamping hub flange (5.4) in both the axial and radial directions. Furthermore, the clamping hub flange (5.4) has a clamping hub bore (5.3) with an internal thread. By using the clamping hub screw (5.2), the clamping hub flange (5.4) can be elastically deformed so that the inner diameter of the clamping hub (5) tapers, and a shaft, which is not shown in FIG. 2, is clamped in the clamping hub (5) without play.

A compression ring hub (6) is shown on the right side of the torque measuring coupling (1). This consists of a compression ring hub flange (6.1), which is connected to the strain gauge sleeve (1.1) via a lamellae connection (2), and a compression ring (6.3). The compression ring hub flange (6.1) has at least one axially extending compression ring hub slot (6.2). In the region of the compression ring hub slot (6.2), a compression ring (6.3) is placed on the compression hub flange (6.1). The compression ring (6.3) is interrupted by a compression ring slot (6.6). At least one compression ring bore (6.5) with an internal thread is arranged in the region of the compression ring slot (6.6). By means of the compression ring screw (6.4), the compression ring (6.3) and with it the compression ring hub flange (6.1) can be elastically deformed and thus tapered. In this way, a shaft, not shown in FIG. 2, can be clamped without play.

### LIST OF REFERENCE SIGNS

A Shaft axis
S Distance
1 Torque measuring coupling
1.1 Strain gauge sleeve
1.2 Expansion sleeve
1.3 Sleeve portion
1.4 Coil ring
1.5 Protective tube
1.6 Tube receptacle
1.7 Absorber foil
1.8 Coil
1.9 Potting compound
1.10 Printed circuit board
1.11 Expanding rivet
1.12 Strain gauge
1.13 Flange
1.14 Threaded hole
1.15 Fastening screw
1.16 Contact surface
1.17 Recess
1.18 Threaded hole with radius countersink
1.19
1.20
Pin
Cable feedthrough
2 Lamellae connection
2.1 Lamellae pack
2.2 Lamellae
2.3 Flange bushing
2.4 Ring
2.5 Screw
2.6 Nut
3 Hub
3.1 Hub flange
3.2 Clamping ring hub
3.3 Clamping ring
3.4 Clamping screw
4 Stator
5 Clamping hub
5.1 Clamping hub slot
5.2 Clamping hub screw
5.3 Clamping hub bore
5.4 Clamping hub flange
6 Compression ring hub
6.1 Compression ring hub flange
6.2 Compression ring hub slot
6.3 Compression ring
6.4 Compression ring screw
6.5 Compression ring bore
6.6 Compression ring slot

1.-11. (canceled)

12. A torque measuring coupling (1) consisting of a stator (4) and a torque-transmitting strain gauge sleeve (1.1), wherein the strain gauge sleeve (1.1) is made up of several parts consisting of an expansion sleeve (1.2) and a flange (1.13) attached thereto,
wherein a coil ring (1.4) encloses the expansion sleeve (1.2) axially in sections and radially and has an inner diameter that is smaller than the outer diameter of the flange (1.13),
wherein the coil ring (1.4) is a closed, non-divisible ring and
wherein the coil ring (1.4) accommodates a protective tube (1.5).

13. The torque measuring coupling (1) according to claim 12, wherein the strain gauge sleeve (1.1) is connected to a hub (3, 5, 6) on one or both sides via a lamellar connection (2).

14. The torque measuring coupling (1) according to claim 12, wherein the coil ring (1.4) comprises an aluminum alloy or a plastic or a fiber-reinforced material.

15. The torque measuring coupling (1) according to claim 12, wherein the coil ring (1.4) is pressed or glued onto the expansion sleeve (1.2).

16. The torque measuring coupling (1) according to claim 12, wherein the coil ring (1.4) serves as a carrier for a coil (1.8) and for a printed circuit board (1.10).

17. The torque measuring coupling (1) according to claim 12, wherein the protective tube (1.5) is arranged concentrically with respect to the expansion sleeve (1.2) between the coil ring (1.4) and the expansion sleeve (1.2), and said protective tube encloses the sleeve portion (1.3) radially outwardly.

18. The torque measuring coupling (1) according to claim 17, wherein the protective tube (1.5) is tightly sealed together with a tube receptacle (1.6) of the expansion sleeve (1.2) and by a casting compound (1.9) in the coil ring (1.4) so that no liquid, dusty, or viscous substances can penetrate into the space between the protective tube (1.5) and the expansion sleeve (1.2).

19. The torque measuring coupling (1) according to claim 13, wherein the torsionally rigid and flexurally elastic lamellar connection (2) between the hubs (3, 5, 6) and the strain gauge sleeve (1.1) allows for angular, lateral, and axial misalignment compensation.

20. The torque measuring coupling (1) according to claim 13, wherein the lamellar connection (2) between the hubs (3, 5, 6) and the strain gauge sleeve (1.1) is free of play.

21. The torque measuring coupling (1) according to claim 12, wherein the printed circuit board (1.10) contains an acceleration sensor that is suitable for measuring vibrations.

22. A method for installing a torque measuring coupling (1) consisting of a stator (4) and a torque-transmitting strain gauge sleeve (1.1) constructed from an expansion sleeve (1.2) and a flange (1.13) attached thereto, wherein,
first, a protective tube (1.5) is connected to a closed, non-divisible coil ring (1.4),
then a coil (1.8) is inserted into the coil ring (1.4) and cast with a casting compound (1.9),
only then is the coil ring (1.4) positioned on the expansion sleeve (1.2), whereupon a printed circuit board (1.10) is inserted into the coil ring (1.4) and wired to the coil (1.8) and strain gauges (1.12) before the printed circuit board (1.10) is also cast with the casting compound (1.9), and
a flange (1.13) is then connected to the expansion sleeve (1.2) in a torque-transmitting manner.
